(19) United States
(12) Patent Application Publication
(10) Pub. No.: US 2024/0118183 A1
(43) Pub. Date: Apr. 11, 2024

(54) FINE DUST MEASUREMENT MODULE AND FINE DUST MEASUREMENT DEVICE INCLUDING THE SAME

(71) Applicant: SAMSUNG ELECTRONICS CO., LTD., Suwon-si (KR)

(72) Inventors: Ilhwan KIM, Suwon-si (KR); Gibong SUNG, Seoul (KR); Sejin YOOK, Seou (KR); Seokwhan CHUNG, Suwon-si (KR); Kwangwook CHOI, Suwon-si (KR)

(73) Assignee: SAMSUNG ELECTRONICS CO., LTD., Suwon-si (KR)

(21) Appl. No.: 18/375,289

(22) Filed: Sep. 29, 2023

(30) Foreign Application Priority Data
Sep. 30, 2022 (KR) 10-2022-0124885

(51) Int. Cl. G01N 15/02; G01N 15/06

(52) U.S. Cl. CPC G01N 15/02; G01N 15/06

(57) ABSTRACT

A fine dust measurement module includes a fluid inlet through which a fluid including fine dust is introduced, a first channel through which first fine dust having at least a first diameter, among the fine dust introduced into the fluid inlet, passes, a second channel through which second fine dust having a second diameter that is less than the first diameter, among the fine dust introduced into the fluid inlet, passes, a fine dust detection sensor for sensing fine dust flowing into the second channel, a heater above the fine dust detection sensor, and an orifice upstream of a flow of the second fine dust from the fine dust detection sensor and the heater.

### CROSS-REFERENCE TO RELATED APPLICATION

This application is based on and claims priority to Korean Patent Application No. 10-2022-0124885, filed on Sep. 30, 2022, in the Korean Intellectual Property Office, the disclosure of which is incorporated by reference herein in its entirety.

### BACKGROUND

### 1. Field

The disclosure relates to a fine dust measurement module that can identify fine dust contained in the air, by classifying the fine dust by diameter, and a fine dust measurement device including the fine dust measurement module.

### 2. Description of the Related Art

Dust is classified into total suspended particles (TSP) of particle sizes of 50 μm or less and fine particles of very small particle sizes, depending on the size of the particles. Fine particles or fine dust is classified into fine dust of particulate matter (PM) 10 (i.e., PM10, sometimes classified as fine dust) with a diameter of less than 10 um and fine dust of PM2.5 (sometimes classified as ultrafine dust) with a diameter of less than 2.5 um depending on the size of the particles.

Since fine dust causes environmental pollution and health problems such as damage to the respiratory system of the human body, technologies that measure and provide fine dust concentration are required along with reducing fine dust. In particular, a virtual impactor may be used to measure the concentration of fine dust by classifying fine dust according to the size of the particles of the fine dust.

In the process of measuring the concentration of fine dust using a virtual impactor, there is a concern that the time for measuring the concentration of fine dust by collecting fine dust classified by diameter may increase.

### SUMMARY

Provided are a fine dust measurement module and a fine dust measurement device including the fine dust measurement module, which may quickly and effectively identify fine dust, by classifying fine dust contained in the air by diameter and collecting the classified fine dust.

Additional aspects will be set forth in part in the description which follows and, in part, will be apparent from the description, or may be learned by practice of the presented embodiments.

According to an aspect of an example embodiment, a fine dust measurement module may include a fluid inlet through which a fluid including fine dust is introduced, a first channel through which first fine dust having at least a first diameter, among the fine dust introduced into the fluid inlet, passes, a second channel through which second fine dust having a second diameter that is less than the first diameter, among the fine dust introduced into the fluid inlet, passes, a fine dust detection sensor for sensing fine dust flowing into the second channel, a heater above the fine dust detection sensor, and an orifice upstream of a flow of the second fine dust from the fine dust detection sensor and the heater.

A diameter of the orifice may be configured such that a Stokes number for the second fine dust is in a range of about 0.9 to about 1.05.

The measurement module may include a first inclined portion at a front end of the orifice and having a first inclination angle.

The measurement module may include a second inclined portion at a rear end of the orifice and having a second predetermined inclination angle.

The orifice may include a plurality of orifices including the orifice, and the plurality of orifices may be each spaced apart from each other at an interval along the flow of the second fine dust.

The fine dust detection sensor and the heater may be provided at a rear end of a first orifice of the plurality of orifices that is downstream of the flow of the second fine dust.

The fine dust detection sensor may include a mass detection sensor configured to directly sense a mass of fine dust introduced into the second channel.

A ratio of a first flow rate of the fluid introduced into the first channel to a second flow rate of the fluid introduced into the second channel may be 1:9.

The measurement module may include a flow rate ratio control nozzle in the first channel, where the flow rate ratio control nozzle is configured to adjust a ratio of a first flow rate of fluid introduced into the first channel a second flow rate of fluid introduced into the second channel.

The second channel may include a first sub-channel, a second sub-channel, the first sub-channel and the second sub-channel being branched from each other and around the first channel, and a third sub-channel into which the first sub-channel and the second sub-channel are merged.

The fine dust detection sensor may be arranged in the third sub-channel.

The first channel may include a first sub-channel on a same plane as that of the second channel, a second sub-channel connected to the first sub-channel and on a plane different from that of the second channel, and a third sub-channel connected to the second sub-channel and on a same plane as that of the second channel.

The first channel may include a first connector connecting the first sub-channel with the second sub-channel channel, and a second connector connecting the second sub-channel with the third sub-channel.

The measurement module may include a third channel into which the first channel and the second channel are merged, and a discharge component connected to the third channel and from which the fluid is discharged.

A ratio of a second pressure inside the discharge component to a first pressure inside the third channel is less than or equal to 0.528.

The measurement module may include a choked nozzle between the third channel and the discharge component.

The measurement module may include a pump connected to the discharge component, and configured to adjust an internal pressure of the discharge component.

According to an aspect of an example embodiment, a fine dust measurement device may include a plurality of fine dust measurement modules, each of the plurality of fine dust measurement modules including a fluid inlet through which a fluid including fine dust is introduced, a first channel through which first fine dust having at least a first diameter, among the fine dust introduced into the fluid inlet, passes, a second channel through which second fine dust having a diameter that is less than the first diameter, among the fine dust introduced into the fluid inlet, passes, a fine dust detection sensor configured to sense fine dust flowing into the second channel, a micro heater above the fine dust detection sensor, and an orifice upstream of a flow of the second fine dust from the fine dust detection sensor and the micro heater, and a discharge component connected to each of the plurality of fine dust measurement modules and configured to discharge fluid.

The plurality of fine dust measurement modules may include a first fine dust measurement module, a second fine dust measurement module, and a third fine dust measurement module, and the first fine dust measurement module, the second fine dust measurement module, and the third fine dust measurement module may be arranged in parallel.

The measurement device may include a pump connected to the discharge component, and configured to adjust an internal pressure of the discharge component.

According to an aspect of an example embodiment, a fine dust measurement module may include a first channel through which first fine dust having at least a first diameter passes, a second channel through which second fine dust having a second diameter that is less than the first diameter passes, and an orifice upstream of a flow of the second fine dust, where the second channel includes a first sub-channel, a second sub-channel, the first sub-channel and the second sub-channel being branched from each other and around the first channel, and a third sub-channel into which the first sub-channel and the second sub-channel are merged.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating a fine dust measurement module according to an embodiment;

FIG. 2 is a diagram illustrating an enlarged fine dust classification area according to an embodiment;

FIG. 3 is a diagram illustrating a fine dust measurement module according to an embodiment;

FIG. 4 is a diagram illustrating a fine dust measurement module according to an embodiment;

FIG. 5 is a diagram illustrating an enlarged view of region M illustrated in FIG. 1 according to an embodiment;

FIG. 6 is a diagram illustrating a fine dust measurement module and a flow of fluid according to an embodiment;

FIG. 7A is a diagram illustrating a flow of fluid in an orifice according to an embodiment;

FIG. 7B is a diagram illustrating a flow of fluid in an orifice according to a comparative example of the related art;

FIG. 8 is a diagram illustrating a fine dust measurement module according to an embodiment;

FIG. 9 is a diagram illustrating a third channel, a choked nozzle, a discharge component, and a pump according to an embodiment; and

FIG. 10 is a diagram illustrating a fine dust measurement device according to an embodiment.

### DETAILED DESCRIPTION

Reference will now be made in detail to embodiments, examples of which are illustrated in the accompanying drawings, in which like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The disclosure may apply various transforms and have various embodiments, and particular embodiments are illustrated in the drawings and will be described in detail in the detailed description with reference to the illustrated drawings. The effects and features of the disclosure, and methods of achieving the effects and features, will become apparent with reference to the embodiments described in detail with reference to the drawings. However, the disclosure is not limited to the embodiments disclosed below, but may be implemented in various forms.

Hereinafter, embodiments of the disclosure will be described in detail with reference to the accompanying drawings, and the same or corresponding components will be denoted by the same reference numerals and redundant descriptions thereof will be omitted.

In the following embodiments, when one of various components such as layers, membranes, regions, and plates are said to be “on” another component, this includes not only the case where the one component is “directly on” the other component, but also the case where a third component is placed therebetween. In addition, for convenience of explanation, components may be exaggerated or reduced in size in the drawings. For example, since the size and thickness of each component shown in the drawings are arbitrarily shown for convenience of explanation, the disclosure is not necessarily limited to those illustrated.

In the following embodiments, the x-axis, the y-axis, and the z-axis are not limited to three axes on the orthogonal coordinate system, and may be interpreted as a wide meaning including the same. For example, the x-axis, y-axis, and z-axis may be orthogonal to each other, but may also refer to different directions that are not orthogonal to each other.

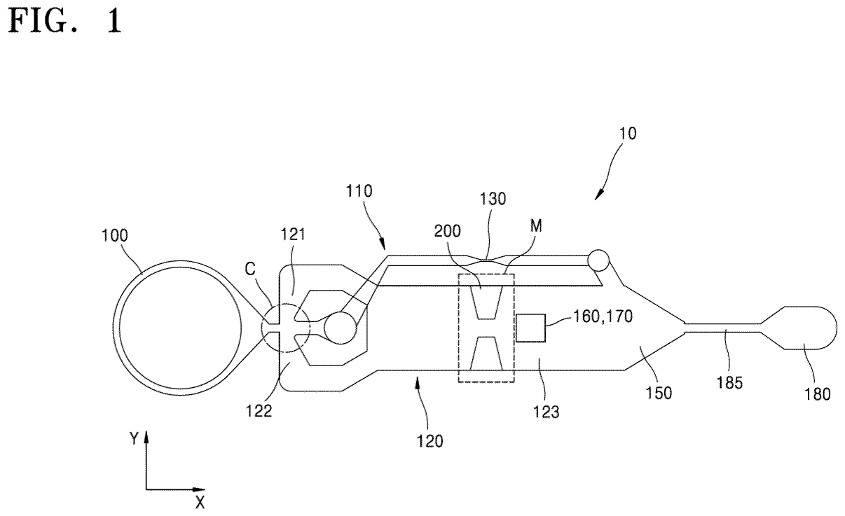

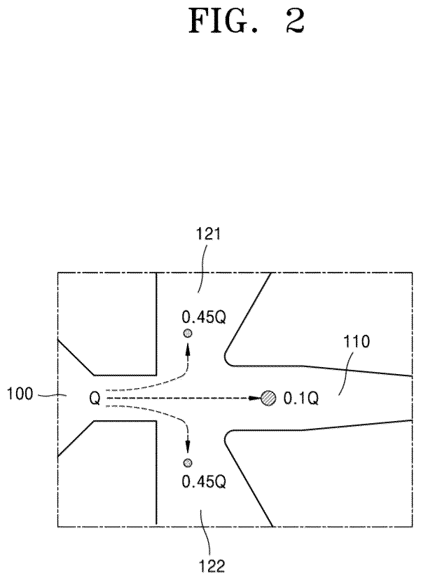

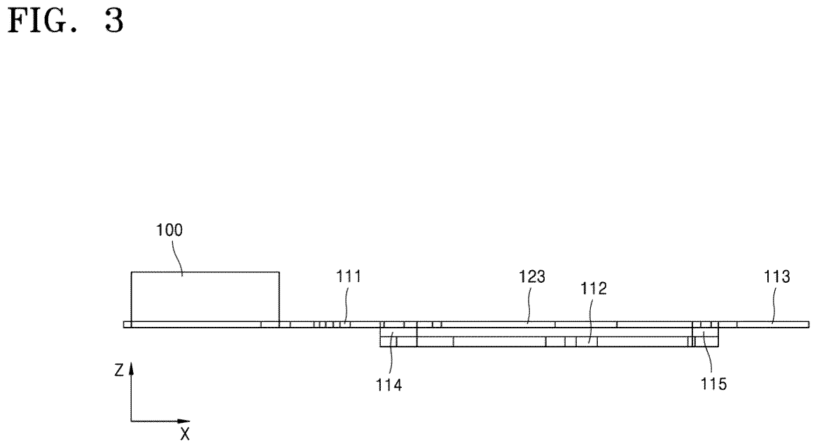

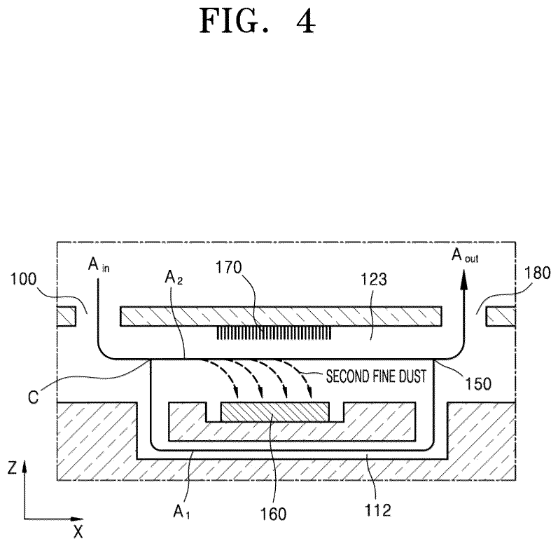

FIG. 1 is a diagram illustrating a fine dust measurement module according to an embodiment. FIG. 2 is a diagram illustrating an enlarged fine dust classification area according to an embodiment. FIG. 3 is a diagram illustrating a fine dust measurement module according to an embodiment. FIG. 4 is a diagram illustrating a fine dust measurement module according to an embodiment.

Referring to FIGS. 1 to 4, the fine dust measurement module 10 according to an embodiment may include a fluid inlet 100, a first channel 110, a second channel 120, a flow rate ratio control nozzle 130, a third channel 150, a fine dust detection sensor 160, a micro heater 170, a discharge component 180, and an orifice 200.

The fluid inlet 100 is a fluid inlet passage through which fluid Aᵢₙ including fine dust may be introduced. The fluid Aᵢₙ including the fine dust is a gas including particles, and may be understood as a concept including, for example, polydisperse aerosol. In addition, the fluid Aᵢₙ introduced into the fluid inlet 100 may include fine dust or ultrafine dust having various diameters. Fine dust or ultrafine dust is distinguished based on the diameter of the particle.

The fluid inlet 100 according to an embodiment may be arranged on the first channel 110 and the second channel 120. Specifically, the fluid inlet 100 may be formed on an upper portion of the first channel 110 and the second channel 120 in a direction facing the first channel 110. In this case, the fluid inlet 100 may have a diameter greater than that of the first channel 110. However, the present disclosure is not limited thereto, and the fluid inlet 100 may have a diameter smaller than or equal to that of the first channel 110.

The fluid Aᵢₙ introduced into the fluid inlet 100 is lowered and moved in a vertical direction by inertia. In this case, particles with great inertia among the aerosol particles included in the fluid Aᵢₙ may be discharged to the first channel 110, and particles with less inertia among the aerosol particles may be discharged to the second channel 120. The first flow may act as a minor flow and the second flow may act as a major flow.

The first channel 110 may classify, according to inertia, aerosol particles included in the fluid Aᵢₙ introduced into the fluid inlet 100. In this case, the first channel 110 may classify first fine dust (e.g., particles having great inertia) having a diameter greater than or equal to a first diameter (e.g., the first diameter may be used as a reference for classifying particle size). The value of the first diameter may be determined by the ratio of the flow rate of the first channel 110 to the flow rate of the second channel 120.

A portion of the first channel 110 according to an embodiment may be formed on a different plane from the second channel 120. As an example, as shown in FIG. 3, the first channel 110 may include a first sub-channel 111, a second sub-channel 112, a third sub-channel 113, a first connector 114, and a second connector 115. The first sub-channel 111 may be arranged to communicate with a lower side of the fluid inlet 100 and may be arranged on the same plane as the second channel 120. The second sub-channel 112 may be connected to the first sub-channel 111 and may be arranged on a different plane from the second channel 120. The third sub-channel 113 may be connected to the second sub-channel 112 and may be arranged on the same plane as the second channel 120. In this case, the first connector 114 may connect the first sub-channel 111 with the second sub-channel 112 extending in the thickness direction (e.g., the X direction) of the fine dust measurement module 10 and arranged on different planes. The second connector 115 may also extend in the thickness direction (e.g., the X direction) of the fine dust measurement module 10 to connect the second sub-channel 112 with the third sub-channel 113, which are arranged on different planes. Accordingly, the second channel 120 may form a third sub-channel 123 into which the first sub-channel 121 and the second sub-channel 122 are merged without interference from the first channel 110.

The second channel 120 may classify, according to inertia, aerosol particles included in the fluid Aᵢₙ introduced into the fluid inlet 100. In this case, the second channel 120 may classify second fine dust (e.g., particles with less inertia) having a diameter that is less than the first diameter.

The second channel 120 according to an embodiment may include the first sub-channel 121 and the second sub-channel 122, which are branched from each other around the first channel 110, and the third sub-channel 123 into which the first sub-channel 121 and the second sub-channel 122 are merged. As an example, as shown in FIG. 2, the first sub-channel 121 and the second sub-channel 122 may extend in a direction opposite to each other between the fluid inlet 100 and the first channel 110, and may be formed to communicate with each other. That is, the first sub-channel 121 and the second sub-channel 122 may be arranged to face each other from a fine dust classification region C formed between the fluid inlet 100 and the first channel 110, and are formed to communicate with each other.

The third sub-channel 123 may be formed by merging the first sub-channel 121 and the second sub-channel 122. In this case, the second fine dust (e.g., having particles with less inertia) having diameters less than the first diameter classified in the fine dust classification area C may be collected in the third sub-channel 123. As shown in FIG. 2, a portion of the first channel 110, for example, the twelfth channel 112 may be formed in a different plane from the third sub-channel 123. Accordingly, the third sub-channel 123 may aggregate the second fine dust (e.g., having particles having less inertia) having diameters less than the first diameter without interference with the first channel 110. In this case, the fine dust detection sensor 160 may be arranged in the third sub-channel 123. Accordingly, the concentration of target fine dust, for example, second fine dust (e.g., having particles with less inertia), may be detected using one fine dust detection sensor 160.

The flow rate ratio control nozzle 130 may be arranged in the first channel 110 to adjust the flow rate ratio of the fluid introduced into the first channel 110 and the second channel 120. As an example, as shown in FIG. 2, the flow rate Q of the fluid Aᵢₙ introduced through the fluid inlet 100 may be divided and introduced into the first channel 110 and the second channel 120 (e.g., more specifically, the first sub-channel 121 and the second sub-channel 122). In this case, the flow rate ratio control nozzle 130 may adjust the ratio between the flow rate of the first fluid A₁ introduced into the first channel 110 and the flow rate of the second fluid A₂ introduced into the first sub-channel 121 and the second sub-channel 122 by adjusting the cross-sectional area of the flow rate ratio control nozzle 130. For example, the flow rate 0.1 Q of the first fluid A₁ introduced into the first channel 110 may be about 10% of the flow rate Q of the fluid Aᵢₙ introduced through the fluid inlet 100, and the flow rate 0.45 Q of the fluid introduced into the first sub-channel 121 and the second sub-channel 122, respectively may be about 45% of the flow rate Q of the fluid Aᵢₙ introduced through the fluid inlet 100. That is, the ratio of the flow rate of the first fluid A₁ introduced into the first channel 110 to the flow rate of the second fluid A₂ introduced into the second channel 120 may be 1:9.

The third channel 150 may be a merged channel in which the first fluid A₁ passing through the first channel 110 and the second fluid A₂ passing through the second channel 120 are merged. As an example, the third channel 150 may be arranged to be in fluid communication with the discharge component 180 with the choked nozzle 185 therebetween.

The fine dust detection sensor 160 is a detection unit that detects the concentration of the second fine dust (e.g., having particles with less inertia) introduced into the second channel 120. As an example, the fine dust detection sensor 160 may employ a weight measurement method, a beta ray measurement method, a light scattering measurement method, or the like for directly measuring the mass of fine dust, but the present disclosure is not limited thereto. The fine dust detection sensor 160 according to an embodiment may be implemented as a mass detection sensor that directly measures the mass of fine dust, and the mass detection sensor may use one or more of a surface acoustic wave measurement method, a bulk acoustic wave measurement method, and a quartz crystal microbalance measurement method.

As described above, a portion of the first channel 110 may be arranged on a plane different from that of the second channel 120, and the third sub-channel 123 into which the first sub-channel 121 and the second sub-channel 122 merge may be formed. In this case, the fine dust detection sensor 160 may be arranged in the third sub-channel 123. Accordingly, it may not be necessary to separately arrange the fine dust detection sensor 160 in the first sub-channel 121 and the second sub-channel 122, and the concentration of the second fine dust (e.g., having particles with less inertia) may be measured using one fine dust detection sensor 160.

The micro heater 170 may be a heating unit that applies heat to the second fine dust (e.g., having particles with less inertia) introduced into the second channel 120. The micro heater 170 according to an embodiment may be arranged above the fine dust detection sensor 160 to apply heat to the second fine dust (e.g., having particles with less inertia) introduced into the second channel 120. In this case, the second fine dust (e.g., having particles with less inertia) may be collected in the fine dust detection sensor 160 due to a thermophoretic effect.

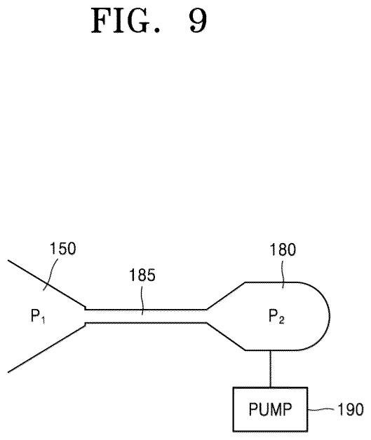

The discharge component 180 may be a discharge member capable of discharging, to the outside, the fluid Aₒᵤₜ whose concentration of the second fine dust (e.g., having particles with less inertia) has been measured. As an example, the discharge component 180 may be arranged to be in fluid communication with the third channel 150 with the choked nozzle 185 therebetween. The internal pressure of the discharge component 180 may be adjusted by the pump 190 (see FIG. 9). A first pressure P₁ (see FIG. 9) inside the third channel 150 and a second pressure P₂ (see FIG. 9) inside the discharge component 180 may be maintained at a predetermined ratio or less, thereby controlling the flow rate of the fluid flowing in the fine dust measurement module 10.

The orifice 200 may collect the second fine dust collected by the fine dust detection sensor 160 by making the stream of the second fine dust (e.g., having particles with less inertia) introduced into the second channel 120 in a straight line. The orifice 200 according to an embodiment may be arranged in the second channel 120, for example, the third sub-channel 123, and may be arranged upstream of the flow of the second fine dust from the fine dust detection sensor 160 and the micro heater 170. Accordingly, the stream of second fine dust collected between the fine dust detection sensor 160 and the micro heater 170 passes, so that the second fine dust may be quickly collected in the fine dust detection sensor 160.

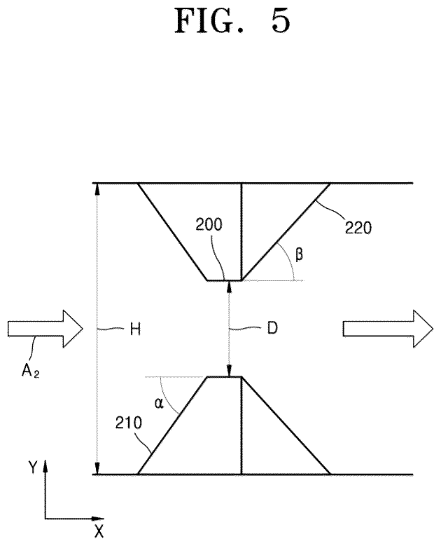

According to an embodiment, the ability to collect second fine dust included in the second fluid A₂ may be determined according to the Stokes number of the second fine dust. Hereinafter, the second fine dust collected according to the Stokes number will be described with reference to FIGS. 5 to 7B.

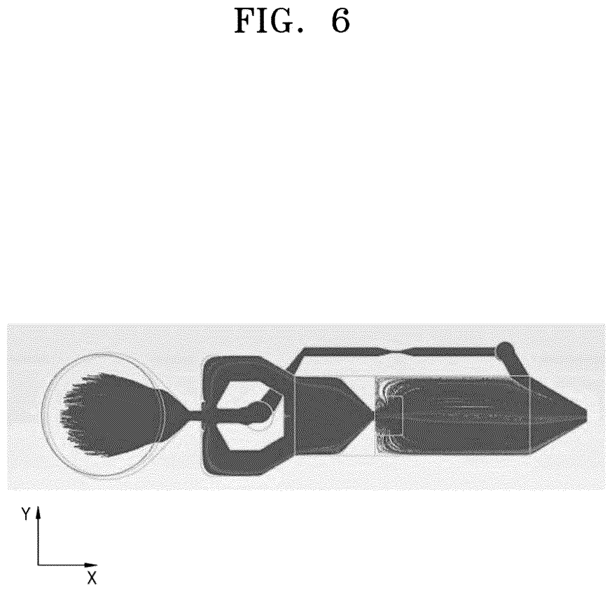

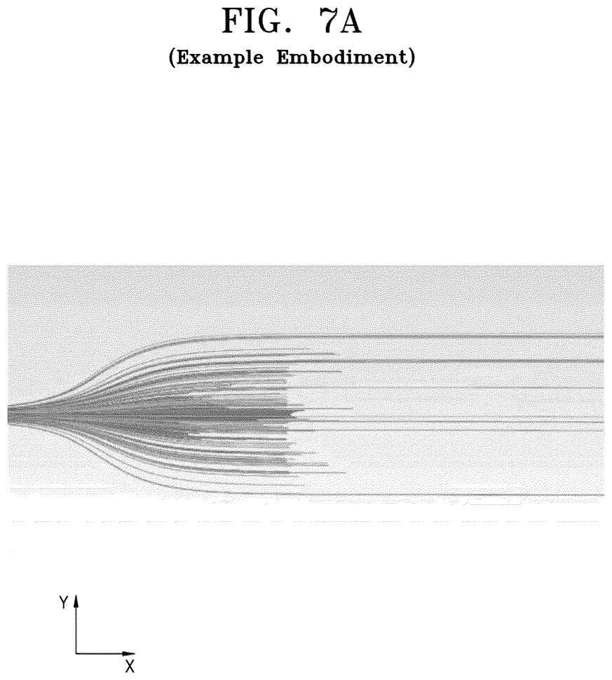

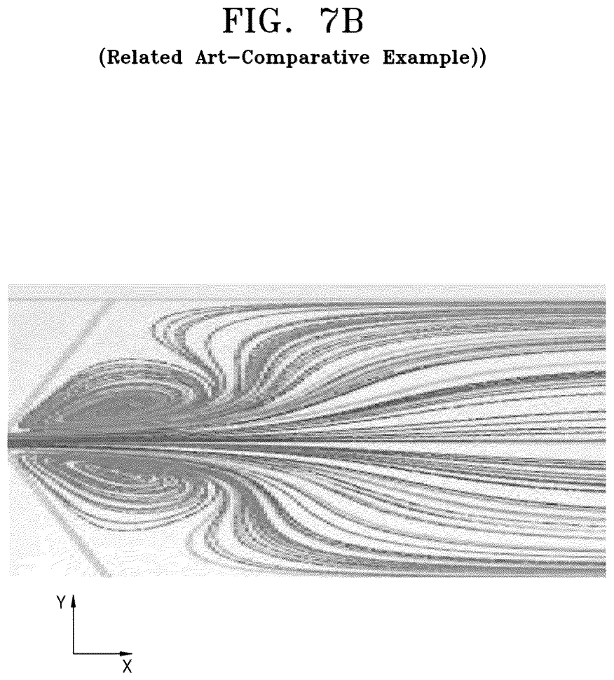

FIG. 5 is a diagram illustrating an enlarged view of region M illustrated in FIG. 1 according to an embodiment. FIG. 6 is a diagram illustrating a fine dust measurement module and a flow of fluid according to an embodiment. FIG. 7A is a diagram illustrating a flow of fluid in an orifice according to an embodiment. FIG. 7B is a diagram illustrating a flow of fluid in an orifice according to a comparative example of the related art.

Referring to FIGS. 1, 4, 5, and 6, the orifice 200 according to an embodiment may be arranged in the second channel 120, for example, the third sub-channel 123. The fluid Aᵢₙ introduced through the fluid inlet 100 is branched into the first channel 110 and the second channel 120, in the fine dust classification region C. According to an embodiment, some of the fluid Aᵢₙ introduced through the fluid inlet 100 may be branched into the first fluid A₁ and introduced into the first channel 110, and the rest of the fluid Aᵢₙ introduced through the fluid inlet 100 may be branched into the second fluid A₂ and introduced into the second channel 120.

For example, the second fluid A₂ introduced into the second channel 120 may be introduced into the third sub-channel 123 through the first sub-channel 121 and the second sub-channel 122. In this case, the third sub-channel 123 may have a predetermined width H to allow the second fluid A₂ to move. According to an embodiment, the orifice 200 may have a diameter D smaller than the width H of the second channel 120, for example, the third sub-channel 123. According to an embodiment, the second fluid A₂ introduced into the third sub-channel 123 is contracted upstream of the orifice 200 while passing through the orifice 200, and then expanded downstream of the orifice 200. According to an embodiment, as the second fluid A₂ passes through the orifice 200, the second fine dust having a predetermined diameter may be collected in a straight line direction.

According to an embodiment, as the second fluid A₂ approaches the orifice 200 and passes through the orifice 200, contraction is generated in the stream of the second fluid A₂. For example, a first inclined portion 210 having a predetermined inclination angle may be arranged in a front end of the orifice 200. The first inclined portion 210 may have a first inclination angle α from the front end of the orifice 200. For example, the first inclination angle α may be about 45 degrees or more and less than about 90 degrees. When the first inclined portion 210 is arranged in the front end of the orifice 200, a cross-sectional area through which the second fluid A₂ passes upstream of the orifice 200 may be reduced. Accordingly, as the second fluid A₂ contracts upstream of the orifice 200, the second fluid A₂ facing the orifice 200 may be collected.

Thereafter, as the second fluid A₂ passes through the orifice 200 and enters an area having a wider cross-sectional area, the second fluid A₂ may be expanded. For example, a second inclined portion 220 having a predetermined inclination angle may be arranged in a rear end of the orifice 200. The second inclined portion 220 may have a second inclination angle α from a rear end of the orifice 200. For example, the second inclination angle β may be about 45 degrees or more and less than about 90 degrees. When the second inclined portion 220 is arranged in the rear end of the orifice 200, a cross-sectional area through which the second fluid A₂ passes downstream of the orifice 200 may be reduced. Accordingly, the vortex generated downstream of the orifice 200 may be alleviated.

According to an embodiment, at least one of the first inclined portion 210 and the second inclined portion 220 may be arranged in a front end or a rear end of the orifice 200. For example, the first inclined portion 210 may be placed at the front end of the orifice 200, the second inclined portion 220 may be placed at the rear end of the orifice 200, or the first inclined portion 210 and the second inclined portion 220 may be placed at the front and rear ends of the orifice 200.

As described above, the ability to collect second fine dust having a predetermined diameter included in the second fluid A₂ may be determined according to the Stokes number of the second fine dust according to Equation (1):

$$S t k = \frac{{ρ}_{p} {d}_{p}^{2} U {C}_{c}}{9 μ D} \qquad ( 1 )$$

where, D may be the diameter of the orifice, ρₚ may be the density of the second fine dust, dₚ may be the diameter of the second fine dust, C_{c} may be the Cunningham slip correction factor, μ may be the viscosity of the second fluid, and ∪ may be the flow velocity of the second fluid.

According to an embodiment, the second fine dust having a predetermined diameter dₚ may be collected toward a numerical value in which the Stokes number is adjacent to 1, for example, a straight line formed at the central portion in a range of about 0.9 or more and about 1.05 or less. When the Stokes number of the second fine dust having a predetermined diameter dₚ deviates from 1, for example, when the Stokes number is less than about 0.9 and greater than about 1.05, the second fine dust may spread outside a straight line formed at the central portion.

According to an embodiment, when the concentration of the second fine dust is measured using the fine dust detection sensor 160, the diameter D of the orifice 200 may be determined such that the Stokes number for the second fine dust is about 0.9 or more and about 1.05 or less. According to an embodiment, when the Stokes number for the second fine dust is about 0.9 or more and about 1.05 or less, the second fine dust passing through the orifice 200 may be collected toward one straight line formed at the central portion. Accordingly, the second fine dust may be quickly detected by collecting the second fine dust between the fine dust detection sensor 160 and the micro heater 170 arranged downstream of the orifice 200 along the flow of the second fine dust.

Referring to FIG. 7A, in the fine dust measurement module 1 according to an embodiment, the second fine dust to be measured is 2.5 PM, and in this case, the diameter D of the orifice 200 may be 90 μm so that the Stokes number according to Equation (1) is 0.93.

Referring to FIG. 7B (e.g., a comparative example of the related art), the second fine dust to be measured is 2.5 PM, and the diameter D of the orifice 200 may be 100 μm so that the Stokes number in accordance with Equation (1) is 1.5.

According to an embodiment shown in FIG. 7A, when the diameter D of the orifice 200 is adjusted so that the Stokes number for the second fine dust is determined to be 0.93, it may be confirmed that the second fine dust passing through the orifice 200 is collected toward a straight line formed at the central portion as illustrated in FIG. 7A. Accordingly, the mass of the second fine dust collected between the fine dust detection sensor 160 and the micro heater 170 arranged downstream of the orifice 200 along the flow of the second fine dust is relatively increased, and thus it may be confirmed that fine dust is detected quickly.

According to the comparative example shown in FIG. 7B, when the diameter D of the orifice 200 is adjusted so that the Stokes number for the second fine dust may be determined to be 1.5, the second fine dust passing through the orifice 200 may spread outside a straight line formed in the center as illustrated in FIG. 7B. Accordingly, the second fine dust is not collected between the fine dust detection sensor 160 and the micro heater 170 arranged downstream of the orifice 200 along the flow of the second fine dust, and thus it may be confirmed that a relatively longer time is needed to detect the fine dust.

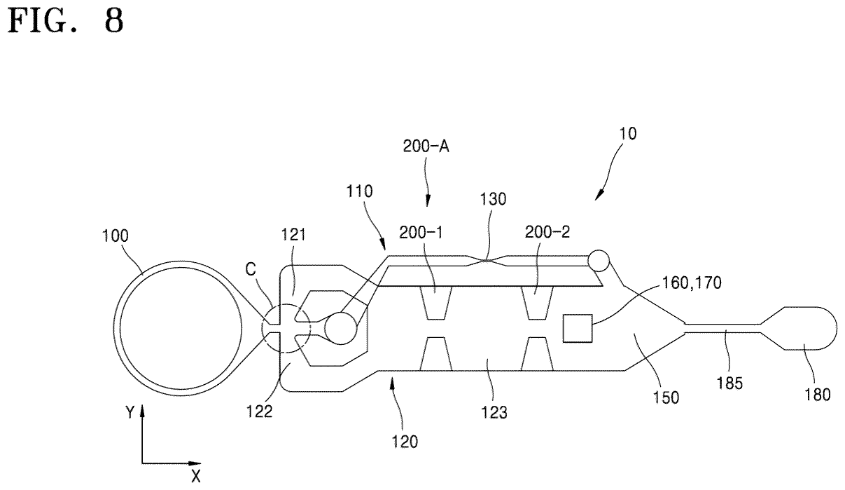

FIG. 8 is a diagram illustrating a fine dust measurement module according to an embodiment. In the embodiments described above, the single orifice 200 may be arranged in the second channel 120, but the present disclosure is not limited thereto.

Referring to FIG. 8, a plurality of orifices 200-A according to an embodiment may be provided and arranged in the second channel 120. For example, the plurality of orifices 200-A may include a first orifice 200-1 and a second orifice 200-2. In this case, the first orifice 200-1 and the second orifice 200-2 may be arranged to be spaced apart from each other at a predetermined interval along the flow of the second fine dust.

The fine dust detection sensor 160 and the micro heater 170 according to an embodiment may be arranged at the rear end of the plurality of orifices 200-A arranged downstream of the flow of the second fine dust. For example, as shown in FIG. 8, when the plurality of orifices 200-A include the first orifice 200-1 and the second orifice 200-2, the fine dust detection sensor 160 and the micro heater 170 may be arranged at the rear end of the second orifice 200-2.

As described above, since the plurality of orifices 200-A are arranged in the second channel 120, the effect of collecting the second fine dust toward one straight line formed at the central portion may be improved. For example, as the second fluid A₂ introduced into the second channel 120 sequentially passes through the first orifice 200-1 and the second orifice 200-2, the effect of collecting the second fine dust toward the straight line formed at the central portion may be sequentially improved. Accordingly, it is possible to detect the second fine dust more quickly by placing the plurality of orifices 200-A than placing a single orifice (e.g., orifice 200 of FIG. 1) along the flow of the second fine dust.

FIG. 9 is a diagram illustrating a third channel, a choked nozzle, a discharge component, and a pump according to an embodiment.

Referring back to FIGS. 1 and 4, the fluid Aᵢₙ introduced through the fluid inlet 100 diverges from the fine dust classification area C to the first channel 110 and the second channel 120. In this case, the concentration of the second fine dust (e.g., having particles with less inertia) introduced into the second channel 120 may be detected by the fine dust detection sensor 160. After the concentration detection of the second fine dust (e.g., having particles with less inertia) is completed, the fluid branched into the first channel 110 and the second channel 120 is merged again into the third channel 150. The fluid merged in the third channel 150 may be discharged to the outside through the discharge component 180. In this case, as described above, the discharge component 180 may be arranged to be in fluid communication with the third channel 150 with the choked nozzle 185 therebetween.

Referring to FIG. 9, as an example, when the choked nozzle 185 is arranged between the third channel 150 and the discharge component 180, and the second pressure P₂ in the discharge component 180 to the first pressure P₁ in the third channel 150 is maintained at a predetermined ratio or less, for example, 0.528 or less, the speed of the fluid passing through the choked nozzle 185 may be kept constant as the speed of sound. For example, by adjusting the second pressure P₂ inside the discharge component 180 to the first pressure P₁ inside the third channel 150 to 0.528 or less using the cross-sectional area of the choked nozzle 185 and one pump 190 connected to the discharge component 180, the speed of the fluid passing through the choked nozzle 185 may be kept constant as the speed of sound. Accordingly, the flow rate of the fluid flowing through the fine dust measurement module 10 may be constantly controlled, and thus, the measurement accuracy of fine dust may be improved.

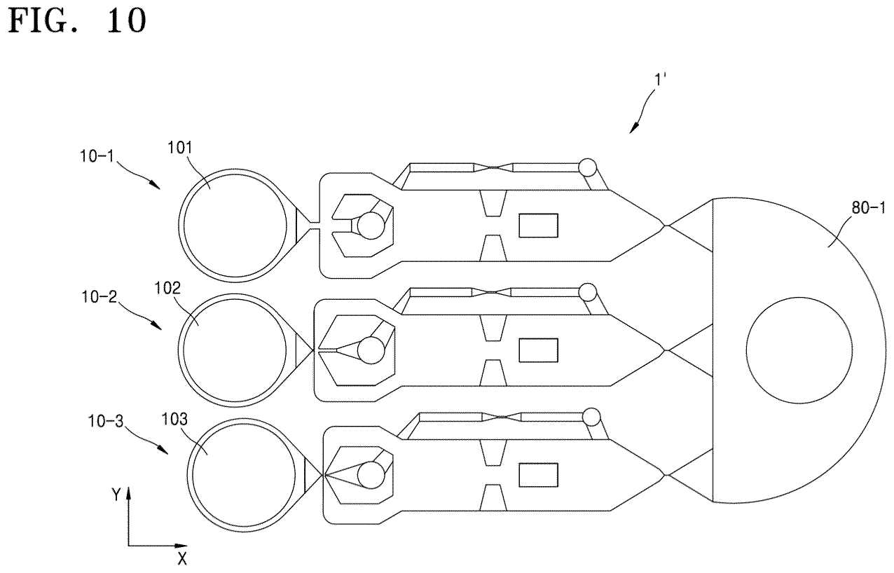

FIG. 10 is a diagram illustrating a fine dust measurement device according to an embodiment.

Referring to FIG. 10, a fine dust measurement device 1′ according to an embodiment may include a first fine dust measurement module 10-1 including a first fluid inlet 101 through which a fluid including fine dust is introduced, a second fine dust measurement module 10-2 including a second fluid inlet 102 through which a fluid including fine dust is introduced, a third fine dust measurement module 10-3 including a third fluid inlet 103 through which a fluid including fine dust is introduced, and a discharge component 80-1 connected to the first fine dust measurement module 10-1, the second fine dust measurement module 10-2 and the third fine dust measurement module 10-3 to discharge the fluid. As an example, the first to third fine dust measurement modules 10-1 to 10-3 may be arranged on the same plane in parallel with a predetermined interval therebetween. In the aforementioned embodiment, three fine dust measurement modules included in the fine dust measurement device 1 are implemented, but the present disclosure is not limited thereto. There may be two or more than three fine dust measurement modules included in the fine dust measurement device 1. Each of the first to third fine dust measurement modules 10-1 to 10-3 according to an embodiment may be substantially the same as the fine dust measurement module 10 shown in FIGS. 1 to 4, and thus description thereof will be omitted for convenience of explanation.

According to an embodiment, the first diameter of fine dust classified by the first fine dust measurement module 10-1, the second diameter of fine dust classified by the second fine dust measurement module 10-2, and the third diameter of fine dust classified by the third fine dust measurement module 10-3 may be different. The diameters of fine dust classified in the first to third fine dust measurement modules 10-1 to 10-3 may be differently determined depending upon the cross-sectional areas of the connectors connecting the fluid inlet with the channels, respectively.

As an example, the pressure inside the third channel and the pressure inside the discharge component provided in each of the first to third fine dust measurement modules 10-1 to 10-3 may be adjusted using a cross-sectional area of the choked nozzle provided in each of the first to third fine dust measurement modules 10-1 to 10-3 and the pump connected to the discharge component 80. That is, by adjusting the relative pressure using the cross-sectional area of the choked nozzle provided in each of the first to third fine dust measurement modules 10-1 to 10-3 and the one pump connected to the discharge component 80-1, the flow rate of the fluid flowing in the first to third fine dust measurement modules 10-1 to 10-3 may be uniformly controlled, thereby increasing the measurement accuracy of fine dust.

One or more embodiments provide a fine dust detection module and a fine dust measurement device including same, the fine dust detection module allowing fine dust to be quickly collected by a fine dust detection sensor (mass sensor) by collecting fine dust through an orifice in a process of measuring fine dust using a fine dust measurement module, thereby quickly and effectively detecting fine dust.

According to an embodiment of the disclosure as described above, it is possible to implement a fine dust measurement module and a fine dust measurement device that are simple in configuration and may classify fine dust in the air by diameter and collect and identify the classified fine dust quickly and effectively. However, the scope of the disclosure is not limited by such an effect.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A fine dust measurement module comprising:
a fluid inlet through which a fluid comprising fine dust is introduced;
a first channel through which first fine dust having at least a first diameter, among the fine dust introduced into the fluid inlet, passes;
a second channel through which second fine dust having a second diameter that is less than the first diameter, among the fine dust introduced into the fluid inlet, passes;
a fine dust detection sensor configured to sense fine dust flowing into the second channel;
a heater above the fine dust detection sensor; and
an orifice upstream of a flow of the second fine dust from the fine dust detection sensor and the heater.

2. The fine dust measurement module of claim 1, wherein a diameter of the orifice is configured such that a Stokes number for the second fine dust is in a range of about 0.9 to about 1.05.

3. The fine dust measurement module of claim 1, further comprising a first inclined portion at a front end of the orifice and having a first inclination angle.

4. The fine dust measurement module of claim 1, further comprising a second inclined portion at a rear end of the orifice and having a predetermined second inclination angle.

5. The fine dust measurement module of claim 1, further comprising a plurality of orifices including the orifice, and
wherein the plurality of orifices are each spaced apart from each other at an interval along the flow of the second fine dust.

6. The fine dust measurement module of claim 5, wherein the fine dust detection sensor and the heater are provided at a rear end of a first orifice of the plurality of orifices that is downstream of the flow of the second fine dust.

7. The fine dust measurement module of claim 1, wherein the fine dust detection sensor comprises a mass detection sensor configured to directly sense a mass of fine dust introduced into the second channel.

8. The fine dust measurement module of claim 1, wherein a ratio of a first flow rate of the fluid introduced into the first channel to a second flow rate of the fluid introduced into the second channel is 1:9.

9. The fine dust measurement module of claim 1, further comprising a flow rate ratio control nozzle in the first channel,
wherein the flow rate ratio control nozzle is configured to adjust a ratio of a first flow rate of fluid introduced into the first channel a second flow rate of fluid introduced into the second channel.

10. The fine dust measurement module of claim 1, wherein the second channel comprises:
a first sub-channel;
a second sub-channel, the first sub-channel and the second sub-channel being branched from each other and around the first channel; and
a third sub-channel into which the first sub-channel and the second sub-channel are merged.

11. The fine dust measurement module of claim 10, wherein the fine dust detection sensor is provided in the third sub-channel.

12. The fine dust measurement module of claim 1, wherein the first channel comprises:
a first sub-channel on a same plane as that of the second channel;
a second sub-channel connected to the first sub-channel and on a plane different from that of the second channel; and
a third sub-channel connected to the second sub-channel and on a same plane as that of the second channel.

13. The fine dust measurement module of claim 12, wherein the first channel further comprises:
a first connector connecting the first sub-channel with the second sub-channel; and
a second connector connecting the second sub-channel with the third sub-channel.

14. The fine dust measurement module of claim 1, further comprising:
a third channel into which the first channel and the second channel are merged; and
a discharge component connected to the third channel and from which the fluid is discharged.

15. The fine dust measurement module of claim 14, wherein a ratio of a second pressure inside the discharge component to a first pressure inside the third channel is less than or equal to 0.528.

16. The fine dust measurement module of claim 15, further comprising a choked nozzle between the third channel and the discharge component.

17. The fine dust measurement module of claim 15, further comprising a pump connected to the discharge component and configured to adjust an internal pressure of the discharge component.

18. A fine dust measurement device comprising:
a plurality of fine dust measurement modules, each of the plurality of fine dust measurement modules comprising:
a fluid inlet through which a fluid comprising fine dust is introduced;
a first channel through which first fine dust having at least a first diameter, among the fine dust introduced into the fluid inlet, passes;
a second channel through which second fine dust having a diameter that is less than the first diameter, among the fine dust introduced into the fluid inlet, passes;
a fine dust detection sensor configured to sense fine dust flowing into the second channel;
a heater above the fine dust detection sensor; and
an orifice upstream of a flow of the second fine dust from the fine dust detection sensor and the heater; and
a discharge component connected to each of the plurality of fine dust measurement modules and configured to discharge fluid.

19. The fine dust measurement device of claim 18, wherein the plurality of fine dust measurement modules comprises a first fine dust measurement module, a second fine dust measurement module, and a third fine dust measurement module, and
wherein the first fine dust measurement module, the second fine dust measurement module, and the third fine dust measurement module are arranged in parallel.

20. The fine dust measurement device of claim 18, further comprising a pump connected to the discharge component and configured to adjust an internal pressure of the discharge component.
